(19) United States
(12) Patent Application Publication
(10) Pub. No.: US 2004/0246933 A1
(43) Pub. Date: Dec. 9, 2004

(54) Arrangements and method in mobile internet communications systems

(76) Inventors: Andras Valko, Budapest (HU); Adam Magi, Budapest (HU); Zoltan Turanyi, Budapest (HU)

Correspondence Address: ERICSSON INC., 6300 LEGACY DRIVE, M/S EVR C11, PLANO, TX, 75024, US

(21) Appl. No.: 10/489,061

(22) PCT Filed: Sep. 10, 2002
(86) PCT No.: PCT/SE02/01620

(30) Foreign Application Priority Data
Sep. 12, 2001 (US) 60322460
Sep. 12, 2001 (US) 60322325

(51) Int. Cl. H04Q 7/24

(52) U.S. Cl. 370/338; 370/329

(57) ABSTRACT

The present invention relates to a session control unit (16) for use in a communication network (11a) for providing wireless access to the Internet for mobile nodes (2). The communication network comprises one or several access routers (3) for wireless communication with mobile nodes and one or several anchor points (12a) for routing data packets to and/or from the mobile nodes via the access routers. The session control unit is arranged to allocate a session identifier to a mobile node (2) requesting access to the network, select an anchor point (12a) to route data packets to and/or from the mobile node, and communicate an IP-address associated with the selected anchor point to the access router communicating with the mobile node. The allocated session identifier is independent of the selected anchor point. The invention also relates to a method for providing session control to a communication network.

### FIELD OF THE INVENTION

The present invention relates to communications systems and methods, and more particularly, to mobile Internet systems and methods of operation thereof

### BACKGROUND OF THE INVENTION

The growing importance of the Internet and of mobile communication creates the demand to attach mobile communication devices to the Internet. The original Internet protocol does not support mobile communication, therefore the Internet protocols must be augmented with mobility support.

Several different types of systems and protocols have been developed to meet the mobility requirement in IP based networks. An example of such a system and protocol is Hierarchical Mobile IEPv6 (HMIPv6). HMIPv6 allows a network to provide wireless Internet access for mobile communication devices such as mobile computers. Mobile computers connected to a HMIPv6 network can send and receive data packets to and from other computers connected to the Internet.

FIG. 1 is a schematic diagram illustrating a HMIPv6 network 1. A mobile node (MN) 2 is able to connect to the HMIPv6 network 1 through access routers (AR) 3 having wireless interfaces. The mobile node represents a mobile device that wish to access the Internet via the network and has a wireless interface and appropriate protocol implementation for this purpose. The mobile node in the HMIPv6 network is associated with a long-term IP address called its permanent home address on a home network 4. The mobile node may change its location without changing its permanent home address. The mobile node is also associated with a home agent (HA) 5. The home agent 5 is a router on the mobile node's home network 4 that tunnels packets for delivery to the mobile node when the mobile node is away from home and maintains information regarding the current location of the mobile node 2.

When the mobile node 2 connects to the HMIPv6 network 1, the mobile node sends a binding update message to a mobility anchor point (MAP) 6 to inform it about its permanent home address and its current on-link care-of address (LCoA) that identifies its current location. The mobility anchor point 6 acts as a local home agent for the mobile node registered with it. Then the mobile node 2 also sends binding update messages to its home agent 5 and to nodes 7 with which the mobile node is communicating, so-called correspondent nodes (CN), to inform them about the mobility anchor point 6 it is currently located at. When the home agent 5 or correspondent nodes 7 need to send a packet to the mobile node 2 they send it to the mobility anchor point 6 based on the information received in the binding update message. The mobility anchor point 6, in turn, forwards the packet to the actual location of the mobile node 2 designated by its LCoA, which is known from the binding update message sent by the mobile node to the mobility anchor point.

HMIPv6 is similar to its predecessor plain Mobile IPv6, which is another system and protocol for providing wireless Internet access for mobile communications device. Plain Mobile IPv6 differs from HMIPv6 in that it does not include any mobility anchor points, which has the disadvantage that the mobile node is required to update all of the correspondent nodes and the home agent when the mobile node moves locally.

In the binding update messages the mobile node 2 is identified by its permanent home address. However, it may be desirable to let the mobile node be associated and reachable by more than one address. In that case the mobile node must send binding update messages for each of its addresses.

The access routers 3 periodically emit router advertisements that are broadcast on the wireless link. The router advertisements are used by the mobile node to discover the access routers and the HMIPv6 networks and to detect movement, i.e. changes in the distance between the mobile node and different access routers. The router advertisements also contain a list of mobility anchor points (identified by their IP addresses) that are serving the given access router. The mobile node may freely select any one of these mobility anchor points, based on pre-configured or dynamically changing preference values assigned to the advertised mobility anchor points and the distance of the mobility anchor point from the access router.

Another mobility protocol which was launched to meet the mobility requirements in IP based networks is the Brain Candidate Mobility Protocol (BCMP) which was developed in the European project “Broadband Radio Access for IP based Networks” (BRAIN). BRAIN is a research and technology development (RTD) project sponsored by the European Commission under the Information Technologies Programme (IST), which is one of the thematic programmes of the Fifth RTD Framework Programme (1998-2002). BCMP have many similarities with HMIPv6. However, BCMP includes functionality for access control and session control which is not present in HMIPv6.

FIG. 2 is a schematic diagram illustrating a BCMP network 11. A mobile node 2 is able to connect to the BCMP network 11 through access routers 3, which correspond to the access routers in the HMIPv6 network 1. In the BCMP network the access routers are usually called Brain Access Routers (BAR). The BCMP network 11 further comprises anchor points (ANP) 12. The anchor points 12 own and allocate IP addresses and forwards packets to the mobile nodes 2 via the access routers 3. The anchor points of the BCMP network have many similarities with the mobility anchor points 6 of the HMIPv6 network 1. However, the anchor points of the BCMP network differ from the mobility anchor points of the HMIPv6 network in that they also authenticate users and maintain user records for access and session control. The BCMP network also comprises one or several gateway routers 13 usually called Brain Mobility Gateways (BMG). The gateway routers 13 shield the rest of the BCMP network 11 from exterior routing protocols and distribute traffic to the appropriate anchor points 12. The gateway routers need not have BCMP specific functionality. Besides these entities, a BCMP network can also incorporate other network entities.

The anchor points 12 have globally routable address space and they allocate IP addresses to the mobile node 2 when it attaches to the BCMP network 11. The pool of IP addresses owned by the anchor point is advertised using legacy IP routing inside the BCMP network 11 and toward external IP networks. This ensures that packets addressed to the mobile node's locally obtained address are routed, using standard IP routing, to the anchor point 12 that allocated the address. The anchor point, in turn, uses IP-in-IP encapsulation to forward the packets to the access router 3 where the mobile node 2 is located at the moment.

When the mobile node 2 first contacts the access router 3 in the BCMP network 11 it must execute a login procedure. First the mobile node 2 sends a login request message to the access router 3 at which it has appeared. In this request the mobile node provides login and security information. The access router 3 selects an anchor point 12 for the mobile node according to a policy specified by an operator of the BCMP network 11 and forwards the login request to it. The mobile node need not be aware of the policy and of the internal structure of the access router. The selected anchor point 12 identifies and authenticates the mobile node and allocates a globally routable IP address and a new session identifier to the mobile node. The session identifier is a temporary identifier used to index control messages in the BCMP network 11. The session identifier, a security key and the IP address are sent back to the mobile node in a login response message.

As the mobile node 2 moves, it can connect to a new access router 3 when necessary. This is called a handover or handoff. The globally routable IP address allocated to the mobile node by the anchor point 12 is kept constant, despite handovers. The anchor points 12 must maintain up-to-date location information of the mobile nodes 2 they have allocated an address to and must update this information when ‘their’ mobile nodes change access router. For this purpose, the access routers 2 notify the anchor points when a handoff occurs. In addition, the BCMP network can incorporate various local handoff mechanisms that improve the performance of handoff by, for example, building a temporary path from the old to the new access router in order to avoid loss of data packets sent to the mobile node.

If the mobile node 2 moves far away from its anchor point 12 then the tunnel between the anchor point 12 and the access router 3 may become very long. In order to avoid long tunnels, the BCMP protocol allows (but does not mandate) the network operator to request that the mobile node changes anchor point. This improves routing efficiency in the BCMP network 11. However, the change of anchor point requires changing the mobile node's IP address which is a global mobility event. Alternatively, operators may choose to accept long tunnels between the anchor points and access routers in order to completely hide mobility from external networks.

The mobile nodes 2 of the HMIPv6 network 1 and the BCMP network 11 communicate with the access routers 3 using radio channels e.g. based on the IEEE 802.11b standard. Other elements of the HMIPv6 network 1 and the BCMP network 11 may be interconnected via any high-speed communication media such as optical cable. Futher information regarding HMIPv6 can e.g. be found in Soliman H, et al., “Hierarcichal MIPv6 mobility management”, IEIF Mobile IP Working Group Internet Draft, draft-ietf-mobileip-hmipv6-04.txt, July 2001. Further information about BCMP can be found in IST-1999-10050 BRAIN, “BRAIN Architecture specifications and models, BRAIN functionality and protocol specification”, Mar. 30, 2001.

### SUMMARY OF THE INVENTION

The present invention is applicable to HMIPv6 networks, BCMP networks as well as networks running a similar protocol. The prior art HMIPv6 and BCMP networks described hereinabove have a number of disadvantages as will be discussed hereinafter.

HMIPv6 is basically a routing protocol. It defines routing entities (mobility anchor points and access routers) but lacks certain infrastructure, functions and protocols desirable in a commercial access network. More specifically, HMIPv6 uses the mobile nodes' IP address to identify terminal devices connected to the network and to serve as a routing identifier as well. This is disadvantageous for several reasons. Firstly, authentication, authorisation and billing may be problematic especially when one subscriber is associated with several terminal devices. Secondly, since the network has no knowledge of the relation of the subscriber and the terminals, it is difficult to provide certain value-added services such as intelligently directing incoming calls or connections to the appropriate terminal of the subscriber associated with several terminals, or alerting the subscriber on all of his/her on-line terminals. Thirdly, the use of the mobile nodes' IP address to identify the attaching terminals is inconvenient when the user of the mobile node has several mobile IP based devices that form a Personal Area Network and access the HMIPv6 network using a single point of attachment (e.g., a mobile phone). According to HMPv6 all of the devices are handled separately and must independently update their location, although they always move together and presumably only one of them is in connection with the HMIPv6 network.

Furthermore, as described above, in HMIPv6 the serving mobility anchor point of the mobile node is selected by the mobile node itself based on the preference value of the given mobility anchor point and its distance from the current access router. This arrangement may provide insufficient control of the choice of mobility anchor point for the mobility node resulting in selection of a non-optimal mobility anchor point, which in turn may result in unbalanced load distribution among the mobility anchor points and sub-optimal routing. It may also prevent the operator of the network from having full control of the network resources. In addition, mobile node controlled selection of mobility anchor point has the inconvenience that network internals, such as the identity (IP address) of the mobility anchor points and their distance from the different access routers must be revealed to the mobile nodes. Moreover, the network has no means for detecting a failure of one of the mobility anchor points and for relocating the mobile node to another mobility anchor point.

A drawback of the BCMP network according to prior art is that the access and session control provided in the network is inefficient. The access and session control of the prior art BCMP network requires each anchor point to store information that is required for access and session control for each of the network's subscribers. This is inconvenient and inefficient, since a new subscriber must be configured in multiple locations. In addition, consistency between these storage places must be maintained.

Moreover, when the mobile node changes anchor point in the prior art BCMP network, it must be allocated a new session identifier. This means that the session identifier does not remain constant while the mobile node is connected to the network. This has the inconvenience that records (for example charging records) associated with the mobile node's one session are not possible to collect and aggregate using a single identifier.

An object of the present invention is to provide an arrangement and a method that provides more efficient access and session control than the prior art networks providing mobile access to the Internet.

The above stated object is achieved by means of a session control unit according to claim 1, a communication network according to claim 11 and by means of a method according to claim 12.

The present invention makes use of a session control unit separate from the anchor point, which handles session control. The session control unit makes it possible to use session identifiers that are independent of the anchor point serving the session, and allows for a more efficient session control and handling of session and subscriber information.

The session control unit according to the invention is adapted for use in a communication network for providing wireless access to the Internet for mobile nodes. The communication network comprises at least one access router for wireless communication with mobile nodes and at least one anchor point for routing data packets to/from the mobile nodes via the at least one access router. The session control unit comprises allocating means for allocating a first session identifier to a first mobile node requesting access to the communication network. The session control unit also comprises selection means for selecting a first anchor point to route data packets to/from the first mobile node and storage means for storing the first session identifier and information identifying the first anchor point. Furthermore, the session control unit according to the invention comprises communication means for communicating the first session identifier and a first IP-address associated with the first anchor point to the access router communicating with the first mobile node. The first session identifier is, according to the invention, independent of the first anchor point.

The method according to the present invention provides session control to a communication network for providing wireless access to the Internet for mobile nodes. The communication network comprises at least one access router for wireless communication with mobile nodes and at least one anchor point for routing data packets to/from the mobile nodes via the at least one access router. In addition the communication network comprises a session control unit. The method includes a login procedure comprising a number of steps performed by the session control unit. These steps include allocating a first session identifier to a first mobile node requesting access to the communication network, selecting a first anchor point to route data packets to/from the first mobile node, storing the first session identifier and information identifying the first anchor point, and communicating the first session identifier and a first IP-address associated with the first anchor point to the access router communicating with the first mobile node. The first session identifier is, according to the invention, independent of the first anchor point.

An advantage of the present invention is that it reduces the risk of overloading anchor points. In the BCMP network according to prior art an anchor point serves both as a router of data packets and as a signalling server that handles login and logout requests. As a consequence, if an anchor point is highly loaded with data packets then it may not be able to process login and logout requests at the speed required. According to an embodiment of the present invention a session control unit will perform session control in the BCMP network such that the anchor point may serve only as a router of data packets.

Another advantage of the present invention is that since the session identifier that is allocated to a session is allocated by the session control unit and is independent from the anchor point serving the session, the session may be identified by the same session identifier for as long as the mobile node is connected to the network. The session identifier will according to the invention remain constant also when the anchor point serving the session is changed. A constant session identifier is convenient when e.g. collecting charging information relating to the session.

A further advantage of the present invention is that it makes it easier to relocate a mobile node engaged in a session to another anchor point, i.e. change the anchor point serving the session. This may be necessary in case of anchor point failure or may be desirable for reasons of load distribution. The anchor point change according to the present invention will involve a change of an IP-address associated with the session, but the session identifier will remain constant.

Yet another advantage of the present invention is that it allows for network operator controlled selection of the anchor points serving different sessions. This provides the operator with better control of network recourses and makes it easier to optimize the operation of the network.

Yet a further advantage of an embodiment of the present invention is that it makes it possible to store access control related subscriber information in a single network location. This is convenient since a new subscriber only needs to be configured in a single location and since there are no problems of maintaining consistency between several storage locations.

Further advantages and objects of embodiments of the present invention will become apparent when reading the following detailed description in conjunction with the drawings.

### BRIEF DESCRIPTION OF THE DRAWINGS

FIG. 1 is a schematic diagram illustrating a HMIPv6 network.

FIG. 2 is a schematic diagram illustrating a BCMP network.

FIG. 3 is a schematic diagram illustrating a BCMP network implementing the present invention.

FIG. 4 is a block diagram illustrating an implementation of a subscriber registry according to the present invention.

FIG. 5 is a block diagram illustrating an implementation of a session control unit according to the present invention.

FIG. 6 is a table illustrating an example of information stored in a session control unit according to the present invention for each session.

FIG. 7 is a schematic diagram illustrating a login procedure of a mobile node to a BCMP network according to an embodiment of the present invention.

FIG. 8 is a schematic diagram illustrating an alternative login procedure of a mobile node to a BCMP network according to an alternative embodiment of the present invention.

FIG. 9 is a schematic diagram illustrating a login procedure of a mobile node to a HMIPv6 network according to an embodiment of the present invention.

FIG. 10 is a schematic diagram illustrating a location update procedure in a HMIPv6 network implementing the present invention.

FIG. 11 is a schematic diagram illustrating a mobility anchor point change procedure in a HMIPv6 network implementing the present invention.

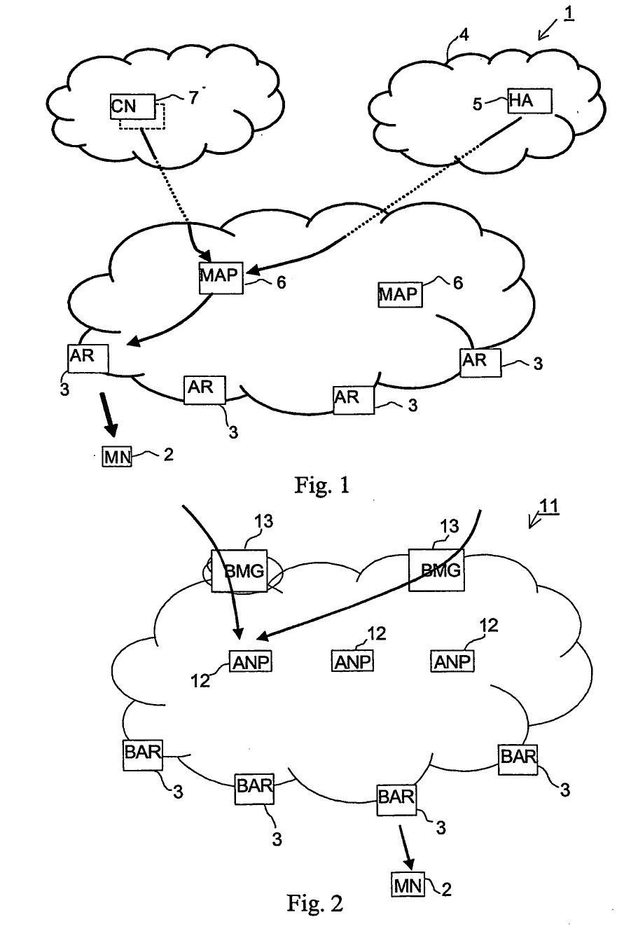

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements.

Unless indicated otherwise, the term “anchor point” will, in this application, be used as a general term comprising both anchor points of a BCMP network, mobility anchor points of a HMIPv6 network and nodes in other types of networks performing the same routing function as the anchor point of the BCMP network and the mobility anchor point of the HMIPv6 network.

The term “session” is used herein to refer to the time period when a subscriber is attached to a network and correspondingly the term “session control” is used to refer to functions of logging in, logging out, maintaining subscriber records in the network and so on. As a comparison it may be mentioned that, often in this field of technology the term “session” is instead used to refer to communication connections (e.g., voice calls) and the term “session control” is then used to refer to the setup and release of such communication connections.

According to the present invention a session control unit is introduced to the network that provides wireless Internet access to mobile devices. The session control unit provides a session control mechanism to the network The session control mechanism may incorporate login and logout procedures including subscriber authentication and access control. In addition, the session control mechanism of the present invention may be used as a back-up context transfer possibility in the case of access router failure, as will be explained below. The session control mechanism may also be responsible for changing the anchor point serving a mobile node, both due to performance reasons and due to anchor point failure. The function of the session control unit according to the invention will be described hereinafter.

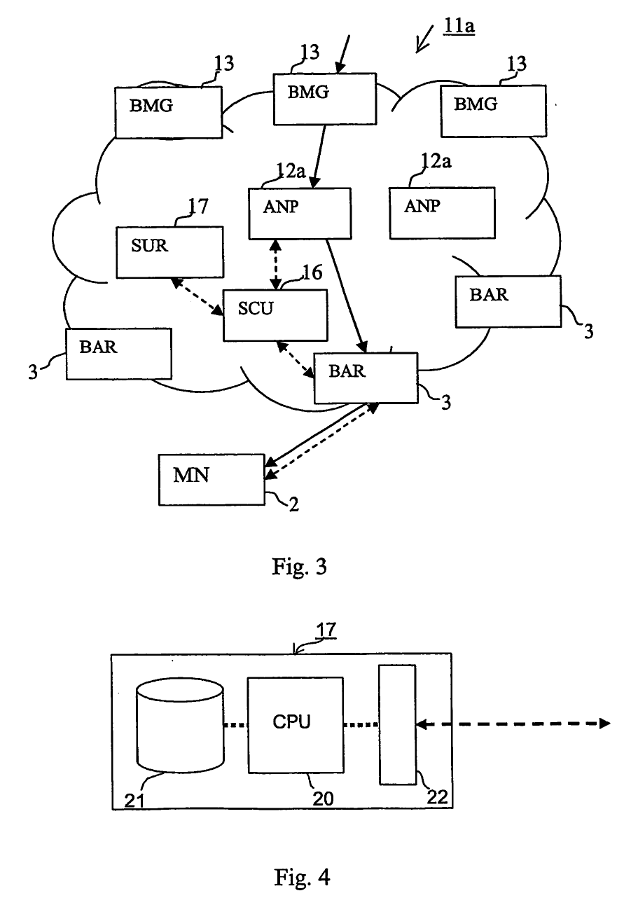

FIG. 3 illustrates a BCMP network 11a implemented according to an embodiment of the present invention. The differences between the prior art BCMP network 11 of FIG. 2 and the BCMP network 11a according to the present invention is that the BCMP network 11a comprises modified anchor points 12a, at least one session control unit (SCU) 16 and at least one subscriber registry (SUR) 17. The function and composition of these three new types of units will be discussed below.

An example of an implementation of the subscriber registry 17 is shown in FIG. 4. The subscriber registry 17 comprises a central processor 20, a data storage device 21 of some kind, e.g. a hard disk, for storing subscriber information and a communication interface for sending and receiving control messages. The positioning and connections of the subscriber registry 17 in the BCMP network 11a are shown in FIG. 3 wherein data flow and signalling are indicated with solid and dashed arrows respectively.

The subscriber registry stores information about subscribers of the network. For each subscriber, it stores a subscriber identifier (also called user identifier or network access identifier), which is included in login request messages. In addition, it can store other information elements, such as a security key, user profile, charging records, etc.

The subscriber identifier uniquely identifies subscription relationships. This permits the BCMP network 11a to store user preferences and subscription parameters indexed by the subscriber identifier for local subscribers in the subscriber registry 17. In addition, the identifier can be used to fetch the subscription parameters from remote networks for roaming subscribers. The subscriber identifier can be of any suitable format such as a Network Access Identifier (NAI) as specified in RFC 2486 (e.g., john.smith@operator.net), an International Mobile Subscriber Identity (MSI) from the GSM system, a phone number, an IPv6 address or another format.

The BCMP network 11a may comprise multiple subscriber registries 17. Each subscriber's information may then be stored in one or multiple subscriber registries. If, for example, each subscriber's information is stored in only one subscriber registry, then subscribers can be assigned to the different subscriber registries based on an alphabetical rule (e.g., information relating to subscriber identifiers starting with a letter A-K are stored in one subscriber registry, others are stored in another one).

The function of the subscriber registry 17 in the BCMP network 11a will be discussed further below.

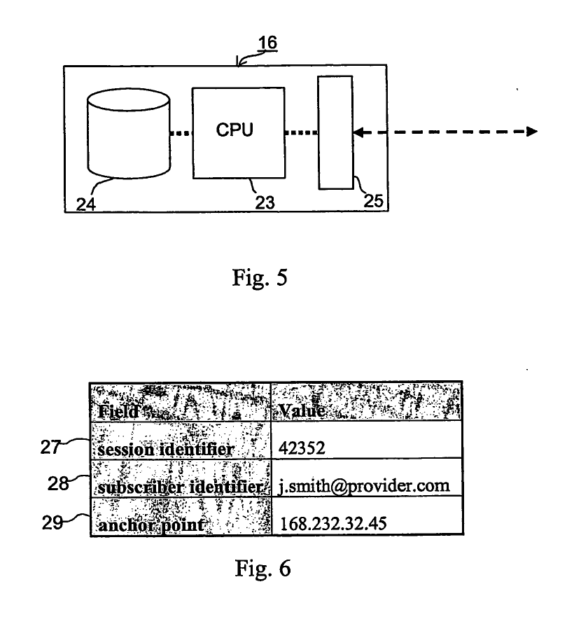

An example of an implementation of the session control unit 16 is shown in FIG. 5. The session control unit comprises a central processor 20, a data storage device 21 of some kind, e.g. a hard disk, for storing information about existing sessions and a communication interface for sending and receiving control messages. The positioning and connections of the session control unit 16 in the BCMP network 11a are shown in FIG. 3.

The operation of the session control unit 16 and the subscriber registry 17 will become apparent from the following description of the operation of the BCMP network 11a of FIG. 3.

Login requests arriving from a mobile node 2 to an access router 3 are forwarded to the session control unit 17, instead of to one of the anchor points 12a as in the BCMP network 11 in FIG. 2. The session control unit allocates a new session identifier for the new session. In addition, the session control unit configures one of the anchor points 12a to allocate an IP address. The session control unit 17 may also perform other steps needed to start a session, for example, create a temporary security key. Finally, the session control unit creates a login reply message and sends it, through the access router 3, to the mobile node 2 that requested login.

The session identifier is an identifier that is assigned to mobile nodes when they connect to the network, but is separate from the subscriber identifiers and the IP address. The session identifier may be in the format of an IP address or in another format. The session identifier is used when updating the location of the mobile nodes. The session identifier can also be used as a technical subscriber identifier for charging records, security associations, quality of service requests, multimedia sessions etc. for the lifetime of the session. According to the present invention, when the mobile node changes anchor point, it will be allocated a new IP address, but it will still use the same session identifier.

Similarly to login requests, logout requests generated by mobile nodes are also forwarded to the session control unit 17 that created the session, instead of to the anchor point 12a. The session control unit clears the session and responds with a login response message (optional).

The table of FIG. 6 shows an example of the information elements stored in the session control unit for each session. The session information stored by the session control unit preferably includes the session identifier 27, the subscriber identifier 28 of the subscriber using the mobile node engaged in the session, an anchor point identifier 29 uniquely identifying the anchor point currently serving the mobile node engaged in the session. The session identifier may for instance be a number uniquely identifying the session. The session identifier must obviously be unique while used, but it is also preferable not to reuse the session identifier for other sessions, or at least not reuse it soon again so that information about the session (e.g., charging records) may be collected, stored and searched based on the session identifier. If the same session identifier is reused then some additional information (e.g. time) must be stored so that collected records associated with the session can be uniquely identified.

With the introduction of the subscriber registry, the operation of the BCMP network changes as follows. When a login request arrives at the session control unit, it checks the subscriber identifier to see if this it is a subscriber of the same network. If the subscriber identifier does not belong to this network then the session control unit can invoke a global Authentication Authorisation and Accounting (AAA) procedure, as specified in BCMP. If, however, the subscriber is the network's own subscriber then the session control unit contacts the subscriber registry. The subscriber registry checks its data base and reads the information relevant for the given subscriber. These information elements are returned to the session control unit, which can use them to start the session. For example, the subscriber registry returns the subscriber's security key, which is needed to check the authentication of the login request message. Alternatively, the global AAA procedure can also be invoked by the subscriber registry.

The anchor point 12a of the BCMP network 11a will continue to handle routing of data packets just as the prior art anchor points 12 of the BCMP network 11. However, with the introduction of the session control unit 16 and the subscriber registry 17 the anchor point is relieved of some of its former functions so that it is no longer required to function both as a router and a signalling server.

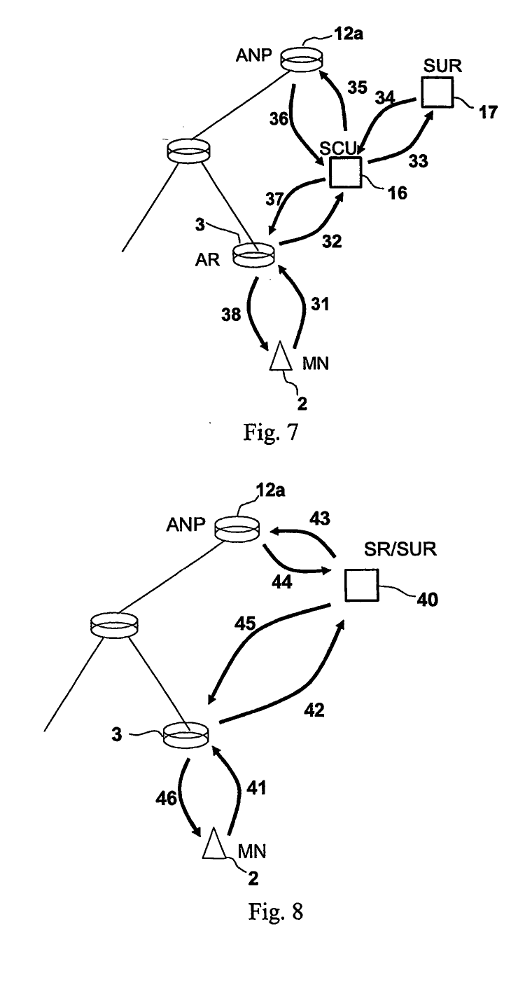

FIG. 7 illustrates the message sequence of a login procedure of the BCMP network 11a. In a first step 31 the mobile node 2 requests login and communicates its associated subscriber identifier to the access router 3. The access router forwards the subscriber identifier to the session control unit 16, step 32, and the session control unit in turn forwards the subscriber identifier to the subscriber registry 17, step 33. The subscriber registry identifies and authenticates the user and communicates an admission or rejection message to the session control unit, step 34. In the case of admission the subscriber registry also communicates subscriber profile information to the session control unit. After additional admission control, the session control unit assigns a session identifier to the session of the mobile node and selects an anchor point 12a to serve the mobile node. Thereafter, the session control unit forwards the assigned session identifier to the selected anchor point, step 35. The anchor point assigns an IP address associated with the anchor point for the session and returns the session identifier along with the assigned IP address to the session control unit, step 36. The session control unit stores information related to the session which is necessary for session control indexed by the session identifier. The session identifier and the assigned IP address is communicated to the access router by the session control unit, step 37. The access router then forwards this information, i.e. the session identifier and the assigned IP address to the mobile node to conclude the login procedure, step 38.

Alternatively, in the login procedure described above, instead of the anchor point assigning the IP address for the session, the session control unit may assign the IP address from among the anchor point's pool of IP addresses.

According to an alternative embodiment of the invention the function of the session control unit 16 and subscriber registry 17 of FIG. 3 are combined in a single network entity. This way all subscriber related information can be stored and managed in a single place. FIG. 8 illustrates the login procedure in the case of a combined session control and subscriber registry unit 40. The mobile node 2 requests login and communicates its associated subscriber identifier to the access router 3 in step 41. The access router forwards the subscriber identifier to the combined session control and subscriber registry unit 40, step 42. The combined session control and subscriber registry unit identifies and authenticates the user and, provided that subscriber passes the authentication, assigns a session identifier to the session of the mobile node and selects an anchor point 12a to serve the mobile node. Thereafter, the combined session control and subscriber registry unit forwards the assigned session identifier to the selected anchor point, step 33. The anchor point assigns an IP address associated with the anchor point for the session and returns the session identifier along with the assigned IP address to the combined session control and subscriber registry unit, step 34. The session identifier and the assigned IP address is then communicated to the access router by the combined session control and subscriber registry unit, step 35. The access router then forwards this information, i.e. the session identifier and the assigned IP address to the mobile node to conclude the login procedure, step 36.

The login procedures described above are initiated by the mobile node and allows it to connect to the network in an authenticated and authorised manner. The login procedures may also serve as a key distribution mechanism to allow the authentication of further session related messages, as will be described further below. Finally, the login procedures allow the network to configure important parameters of the mobile node.

Before logging into the network, the mobile node may constantly monitor beacon messages from the access routers even if the subscriber is not logged in. Beacon messages are transmitted periodically by the access routers over their wireless interfaces to allow mobile nodes to detect the presence of the access routers. The beacon messages contain all the information necessary for the mobile node to perform a handoff to access router. The mobile node may extract the identifiers of available networks in the area from the beacon messages received.

Prior to requesting login the mobile node may send a network solicitation message to the session control unit through the access router. In response, the session control unit may send a network advertisement message that contains all the information necessary for mobile node to login, including the network name and protocol parameters used in the network. Using the information found in the network advertisement message, the mobile node may assemble the login request.

As mentioned above the login procedure may be used as a key distribution mechanism. The key distribution mechanism may for instance involve exchange of security keys to create two security associations. The first security association is between the session control unit and the mobile node, and is used to authenticate session control messages. The second security association is between the access router and the mobile node and is used to authenticate BCMP messages over the air. Alternatively a third security association may be created to protect user data traffic over the air interface. All security associations will preferably have a lifetime and the mobile node will preferably be responsible for renewing the keys of the security associations before expiration.

According to a preferred embodiment of the present invention, the session control unit, in a login procedure, communicates the session identifier and the assigned IP-address to the access router in a login reply message. The login reply message also includes the identity of the selected anchor point. Upon receipt of the login reply message the access router extracts the IP address, session identifier and the identity of the anchor point from the message and creates a context for the mobile. The context is indexed by the session identifier. All further BCMP messages contain the session identifier, so the access router can look up the context for the mobile node. The access router will according to the preferred embodiment remove some of the information from the login reply message (e.g. the identity of the anchor point to hide network internals) and then pass it on to the mobile node. The mobile node will configure its interface with the received IP address and set up routing. As a final step of the login procedure according to the preferred embodiment of the invention, the access router sends a redirect message to the selected anchor point to configure the tunnel for the mobile node to point to the current access router.

Furthermore according to the preferred embodiment of the present invention, each mobile node must periodically refresh its login state kept in the session control unit by means of a resume mechanism. If the association to the network is not refreshed then the session control unit considers the mobile node to be disconnected from the network. This resume mechanism provides state maintenance and also allows the mobile node to renew its security association with the access router.

To initiate the resume mechanism, the mobile node must send a resume request message to its current access router, which forwards it to the session control unit. This resume request message contains the session identifier and is authenticated. Upon receipt of the message the session control unit checks if the session identifier exits and if the authentication is valid. Then it replies to the mobile node with a resume reply message. The resume reply message is first sent to the access router, which may refresh its context with the new information and then forwards the message to the mobile node.

In addition to state maintenance and key renewal, this resume mechanism may also be used as a backup for regular handoff and context transfer. If a mobile node cannot perform a handoff because its old access router is not available or not functioning properly, it can use the resume mechanism to attach to a new access router and obtain the necessary context from session control unit. In this case the mobile node may send the resume request message to any access router in radio range. The resulting resume reply message will re-create the mobile node's context in the access router to which it sent the resume request message, similar to the login procedure. This will allow the continuation of the mobile node operations.

Alternatively, the above backup mechanism may be implemented separately from the resume mechanism, but using the same message for the two mechanisms is a means of protocol optimization.

According to the preferred embodiment of the present invention, the session of the mobile node may be terminated by the session control unit, the access router or by the user of the mobile node. The user of the mobile node may terminate the session when he wishes to disconnect the mobile node from the network. The access router may wish to terminate the session for example if it detects a security breach. The case where the session control unit terminates the session applies e.g. in case of a management action.

If the session control unit wishes to terminate the session, either due to accounting, management or other reasons, it sends a terminate message to the current access router of the mobile node. Depending on the implementation of the network, it may be necessary to poll the anchor point about the identity of the current access router. The terminate message contains a reason code to identify the cause of the action. The access router, in turn, marks the mobile node's context as terminated, stops packet forwarding for the mobile node and replies with a terminate acknowledgement message to the session control unit. In addition, the access router forwards the terminate message to the mobile node, and keeps retransmitting it a few times if the mobile node does not respond with a terminate acknowledgement. Finally, the access router may also send a redirect message to the anchor point to explicitly remove the tunnel created for the session before it times out.

If the user of the mobile node wants to terminate its session, the mobile node sends a logout request message to its current access router. The message is forwarded to the session control unit. If the message is authenticated as correct the session control unit starts the session termination procedure described above by sending a terminate message to the access router. If the mobile node does not receive the terminate message within a pre-specified time, it may assume that the logout request message was lost and that it shall retransmit it.

The preferred embodiment of the present invention comprises an anchor change procedure that allows the change of the serving anchor point of the mobile node during an active ongoing session. However since all anchor points are assigned separate pools of IP addresses, the anchor change procedure results in the change of the IP address allocated to the mobile node.

The anchor change procedure according to the preferred embodiment is designed in such a way as to provide for a smooth transition. This means that the mobile node can keep its old IP address for some time after obtaining its new IP address.

The anchor change procedure may be started either by the mobile node, by the access router (if it detects that the old anchor point is unreachable) or by the session control unit as a network management action. If the initiator is the mobile node or the access router, then the procedure starts by sending an anchor point change request message to the session control unit. This message contains the reason for the anchor point change. From this point on the procedure is the same as the anchor change procedure initiated by the session control unit, which is described hereinafter.

The session control unit first selects a suitable new anchor point for the mobile node and assigns a new IP address from the address pool of the new anchor point. Next, it sends an anchor change message to the access router to inform it about the new IP address and the remaining validity time of the old address. The access router extracts this information and updates the mobile node's context and associated routing state before forwarding the message to the mobile node. The mobile node acknowledges the anchor change in an anchor change acknowledgment message, which is forwarded to the session control unit.

The session control unit of the present invention may, in addition to the functions described above, also be responsible for collecting charging information and assist in billing, co-ordinate and authorise quality of service (QoS) and service requests, and perform any administrative and control functions further required for the session. The login reply message may, in addition to the information mentioned above, carry configuration information for the mobile node such as DNS server, SIP server, charging and QoS information or any DHCP option.

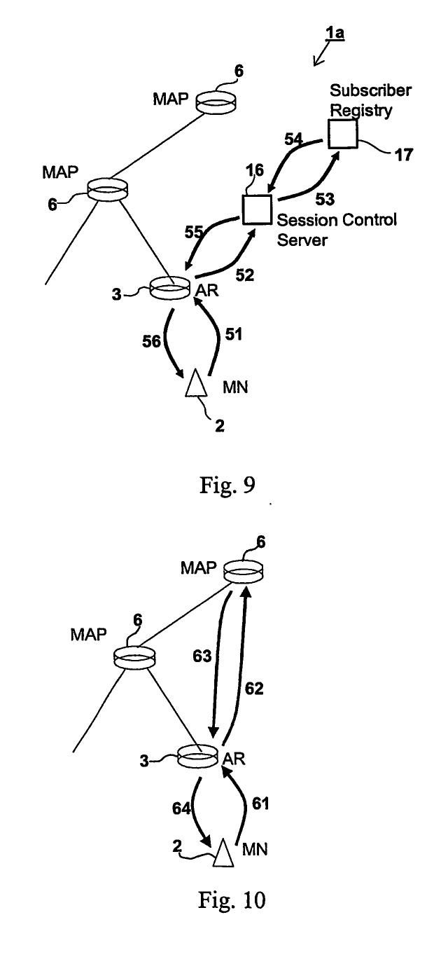

Hereinabove, the present invention has been described when implemented in a BCMP network. However it is also possible to implement the present invention in other types of networks. Now an embodiment of the present invention in a HMIPv6 network will be described. FIG. 9 illustrates a login procedure of a mobile node 3 to a HMIPv6 network 1a comprising a session control unit 16 and a subscriber registry 17 according to the present invention. The login procedure is performed before the mobile node starts sending binding update messages or traffic. The mobile node 2 requests login by sending a login message to the session control unit 16 via an access router 3, steps 51 and 52. This and other messages may be processed by the access router, for example, to hide the internal structure of the network. The login message contains subscriber authentication data and session parameters. The session control server 16 contacts the subscriber registry 17 to authenticate and authorise the subscriber, steps 53 and 54. If the subscriber is a roaming subscriber then the subscriber registry may contact other operators or networks for authentication and authorisation or to fetch subscriber data (steps not shown in FIG. 9). Next, the session control unit sends a session identifier to the mobile node via the access router, steps 55 and 56. Again, the reply message that is sent to the mobile node over the air may be processed or created by the access router. This information exchange can be accomplished using extended binding update messages or signalling messages other than binding update messages.

Alternatively the session control server may omit contacting the subscriber registry. Either because authentication is omitted or because the session control unit and the subscriber registry are combined in a single unit as described above.

After the login procedure is completed, any binding update message that is sent to the mobility anchor point 6 contains the care-of address and the session identifier instead of the home address of the mobile node 2. The mobility anchor point, knowing the corresponding IP address(es) updates its binding cache to point to the given care-of address. This means that incoming data packets addressed to an IP address belonging to a particular session will be routed toward the care-of address that have been sent in the binding update message for the session. Again, similar to the login procedure the access router may process the binding update or binding acknowledgement messages to check or fill authentication fields and to forward messages to/from the mobility anchor points to hide network internals. This location update procedure is shown in FIG. 10 where steps 61 and 62 are the binding update messages while steps 63 and 64 are the binding acknowledgement messages.

The session parameters that are sent to the session control unit in the login message from the mobile node inform the network whether the mobile node wishes to join an existing session or open a new one. In the former case the IP address of the mobile node is added to the session while in the latter a new session is established. During an ongoing session additional signalling may be used to add/remove IP addresses from a session or to entirely abort the session.

As specified in HMIPv6, the mobility anchor point serving the session may be changed based on a request from the mobile node. In addition, the present invention describes a network controlled mobility anchor point selection and change process. The actual identity of the desired mobility anchor point may be selected by the network using an arbitrary algorithm that is configured by the network operator. The entity that decides about the mobility anchor point change in the network may be the old mobility anchor point, the session control unit or a separate entity or function that monitors the status of mobility anchor points in the network and based on this and other information makes mobility anchor point change decisions. Any of these entities might send “mobility anchor point change” messages that contain the new care-of address to the mobile node, so the mobile node can send HMIPv6 binding update messages to correspondent nodes and the home agent. The given care-of address might be the address of the mobility anchor point or a unique care-of address that is allocated specifically for the mobile node at the mobility anchor point. This latter option can be used with the basic mode of HMIPv6 and allows the operator to hide the address of the mobility anchor point from the mobile node.

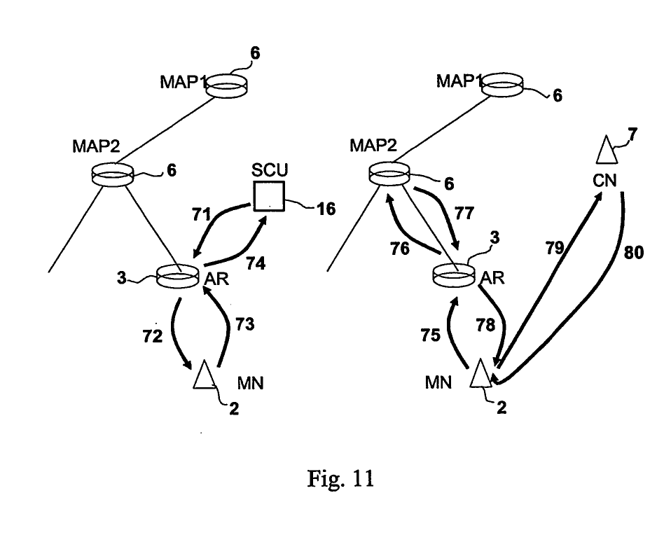

FIG. 11 illustrates a mobility anchor point change controlled by the session control unit. Steps 71-74 represent the “mobility anchor point change message” in which the session control unit notifies the mobile node about its new care-of address. Steps 75-78 represent a binding update and acknowledgement with which the mobile node notifies its new mobility anchor point about its current location. Steps 79 and 80 show how a binding update and acknowledgement is sent/received to/from a correspondent node.

After the mobility anchor point change the old mobility anchor point may remain operational in parallel with the new mobility anchor point for a brief period of time for smooth transition or for longer time for load balancing.

It will be apparent to the person skilled in the art that the present invention may be implemented using known hardware and software means. Session control mechanism according to the present invention may be implemented using a separate protocol created for this purpose.

The present invention has many advantages compared to the prior art. When the present invention is implemented in a BCMP network the risk for overload of anchor points is reduced since the anchor points are relived of their role as a signalling server in addition to their role as a router. When a subscriber registry is introduced according to the present invention the inconvenience that each anchor point must store information about all subscribers of the BCMP network is removed.

A further advantage of the present invention is that it allows for the use of a single session identifier throughout the session irrespective of whether the session involves changing the anchor point that is serving the mobile node engaged in the session.

The present invention provides efficient session control of sessions of local subscribers as well as sessions of roaming subscribers.

When the present invention is implemented in a HMIPv6 network it fixes the inconvenience of using the same identifier to identify mobile users and mobile nodes, it allows an operator to provide custom services more easily, and it allows an operator tighter control on the operation of its subscribers. Furthermore, the invention allows the operator of the HMIPv6 network to have full control over the selection of the mobility anchor point serving the mobile node.

In the drawings and specification, there have been disclosed typical preferred embodiments of the invention and, although specific terms are employed, they are used in a generic and descriptive sense only and not for purposes of limitation, the scope of the invention being set forth in the following claims.

1. A session control unit for use in a communication network for providing wireless access to the Internet for mobile nodes, wherein the communication network comprises at least one access router for wireless communication with mobile nodes and at least one anchor point for routing data packets to and/or from the mobile nodes via the at least one access router, the session control unit comprising:
allocating means for allocating a first session identifier to a first mobile node requesting access to the communication network;
selection means for selecting a first anchor point to route data packets to and/or from the first mobile node;
storage means for storing the first session identifier and information identifying the first anchor point; and
communication means for communicating the first session identifier and a first IP-address associated with the first anchor point to the access router communicating with the first mobile node, wherein the first session identifier is independent of the first anchor point.

2. The session control unit of claim 1, further comprising a subscriber register for storing subscriber information about subscribers of the communication network, which subscriber information includes a subscriber identifier on a per subscriber basis.

3. The session control unit of claim 1, further comprising means for communicating with a remote subscriber registry for requesting and obtaining subscriber information stored in the subscriber registry about a first subscriber of the communication network identified by a subscriber identifier.

4. The session control unit of claim 2, wherein the subscriber information includes one or several of the following types of information:
a security key,
a user profile and
a charging record.

5. The session control unit of claim 4, wherein the session control unit is arranged to deny or admit access of the first mobile node to the communication network based on the subscriber information of the subscriber registry associated with the subscriber using the first mobile node.

6. The session control unit of claim 5, wherein the storage means are arranged to store session information regarding a plurality of ongoing sessions of mobile nodes to the communication network, which session information includes, for each session;
a session identifier,
a subscriber identifier of the subscriber using the mobile node engaged in the session, and
an identifier of the anchor point currently serving the mobile node engaged in the session.

7. The session control unit of claim 6, wherein the session control unit comprises means for clearing a session of a mobile node to the communication network in response to a log out request from the mobile node, which means for clearing a session are arranged to erase the session information, which is associated with the session and stored in the storage means.

8. The session control unit of claim 7, further comprising means for changing the anchor point that is to route data packets to and/or from the first mobile node from the first anchor point to a second anchor point, which means changing the anchor point comprises means for selecting the second anchor point as the new anchor point that is to route data to and/or from the first mobile node, and means for communicating a second IP-address associated with the second anchor point to the access router communicating with the first mobile node.

9. The session control unit of claim 8, wherein the session control unit is arranged for use in a HMIPv6 network wherein the at least one anchor point is at least one mobility anchor point.

10. The session control unit of claim 8, wherein the session control unit is arranged for use in a BCMP network.

11. (Cancelled)

12. A method for providing session control to a communication network for providing wireless access to the Internet for mobile nodes, wherein the communication network comprises
at least one access router for wireless communication with mobile nodes,
at least one anchor point for routing data packets to and/or from the mobile nodes via the at least one access router, and
a session control unit, which method includes a login procedure comprising the steps of
the session control unit allocating a first session identifier to a first mobile node requesting access to the communication network;
the session control unit selecting a first anchor point to route data packets to and/or from the first mobile node;
the session control unit storing the first session identifier and information identifying the first anchor point, and
the session control unit communicating the first session identifier and a first IP-address associated with the first anchor point to the access router communicating with the first mobile node, wherein the first session identifier is independent of the first anchor point.

13. The method of claim 12, further comprising the steps of:
the session control unit receiving; a subscriber identifier associated with a first subscriber using the first mobile node;
checking subscriber information of the first subscriber stored in a subscriber registry in association with the subscriber identifier; and
the session control unit admitting or denying the first mobile node access to the communication network based on the result of the checking of the subscriber information of the first subscriber.

14. The method of claim 13, wherein the subscriber registry is integrated with the session control unit.

15. The method of claim 13, wherein the subscriber registry is remotely located from the session control unit and wherein the session control unit communicates with the subscriber registry via a communication connection of the communication network.

16. The method of claim 15, wherein the session control unit stores session information regarding a plurality of ongoing sessions of mobile nodes to the communication network, which session information includes, for each session,
a session identifier
a subscriber identifier of the subscriber using the mobile node engaged in the session, and
an identifier of the anchor point currently serving the mobile node engaged in the session.

17. The method of claim 16, further comprising the step of clearing a session of a mobile node to the communication network in response to a logout request from the mobile node, which step of clearing a session includes the session control unit erasing the session information, which is associated with the session and stored by the session control unit.

18. The method of claim 17, further comprising the steps of:
changing the anchor point that is to route data packets to and/or from the first mobile node from the first anchor point to a second anchor point, which step of changing anchor point involves the step of
the session control unit selecting the second anchor point as the new anchor point that is to route data to and/or from the first mobile node, and the step of
communicating a second IP-address associated with the second anchor point to the access router communicating with the first mobile node, while maintaining the first session identifier as the session identifier associated with the session of the first mobile node to the communication network.

19. The method of any of claim 18,
wherein the method is a method for providing session control in a HMIPv6 network wherein the at least one anchor point is at least one mobility anchor point.

20. The method of claim 18, wherein the method is a method for providing session control in a BCMP network.

21. A communication network for providing wireless access to the Internet for mobile nodes, wherein the communication network comprises:
at least one access router for wireless communication with mobile nodes,
at least one anchor point for routing data packets to and/or from the mobile nodes via the at least one access router and
a session control unit, the session control unit comprising:
allocating means for allocating a first session identifier to a first mobile node requesting access to the communication network;
selection means for selecting a first anchor point to route data packets to and/or from the first mobile node;
storage means for storing the first session identifier and information identifying the first anchor point; and
communication means for communicating the first session identifier and a first IP-address associated with the first anchor point to the access router communicating with the first mobile node, wherein the first session identifier is independent of the first anchor point.

22. The communication network of claim 21, wherein the session control unit further comprises a subscriber register for storing subscriber information about subscribers of the communication network, which subscriber information includes a subscriber identifier on a per subscriber basis.

23. The communication network of claim 21, wherein the session control unit further comprises means for communicating with a remote subscriber registry for requesting and obtaining subscriber information stored in the subscriber registry about a first subscriber of the communication network identified by a subscriber identifier.

24. The communication network of claim 22, wherein the subscriber information includes one or several of the following types of information:
a security key,
a user profile and
a charging record.

25. The communication network of claim 24, wherein the session control unit is arranged to deny or admit access of the first mobile node to the communication network based on the subscriber information of the subscriber registry associated with the subscriber using the first mobile node.

26. The communication network of claim 25, wherein the storage means are arranged to store session information regarding a plurality of ongoing sessions of mobile nodes to the communication network, which session information includes, for each session;
a session identifier,
a subscriber identifier of the subscriber using the mobile node engaged in the session, and
an identifier of the anchor point currently serving the mobile node engaged in the session.

27. The communication network of claim 26, wherein the session control unit further comprises means for clearing a session of a mobile node to the communication network in response to a logout request from the mobile node, which means for clearing a session are arranged to erase the session information, which is associated with the session and stored in the storage means.

28. The communication network of claim 27, wherein the session control unit further comprises
means for changing the anchor point that is to route data packets to and/or from the first mobile node from the first anchor point to a second anchor point, wherein the means for changing the anchor point comprises
means for selecting the second anchor point as the new anchor point that is to route data to and/or from the first mobile node, and
means for communicating a second IP-address associated with the second anchor point to the access router communicating with the first mobile node.

29. The communication network of claim 28, wherein the session control is arranged for use in a HMIPv6 network wherein the at least one anchor point is at least one mobility anchor point.

30. The communication network of claim 27, wherein the session control unit is arranged for use in a BCMP network.
